(19) United States
(12) Patent Application Publication
(10) Pub. No.: US 2014/0001403 A1
(43) Pub. Date: Jan. 2, 2014

(54) PHOSPHORS AND LIGHT EMITTING APPARATUS

(71) Applicant: NATIONAL TAIWAN UNIVERSITY, (US)

(72) Inventors: Chung-Hsin LU, Taipei (TW); Che-Yuan YANG, Taipei (TW)

(73) Assignee: NATIONAL TAIWAN UNIVERSITY, Taipei (TW)

(21) Appl. No.: 13/854,151

(22) Filed: Apr. 1, 2013

(30) Foreign Application Priority Data
Apr. 2, 2012 (TW) 101111664

(51) Int. Cl. C09K 11/77

(52) U.S. Cl. CPC C09K 11/7783; C09K 11/7743; C09K 11/7766
USPC 252/301.4 F; 423/263; 428/402

(57) ABSTRACT

Provided is a phosphor which comprises alkali earth ions, Si ion, N ion and Tb ion. Tb ion is used as a luminescence center. The phosphor has broad emission bands after excitation. The phosphor of the present invention can be used for a light emitting apparatus, and meets the need of the industrial application.

### RELATED APPLICATIONS

This application claims priority to Taiwanese Application Serial Number 101111664, filed Apr. 2, 2012, which is herein incorporated by reference.

### BACKGROUND

1. Field of Invention

The present invention relates to a phosphor. More particularly, the present invention relates to a phosphor suitable for a light emitting diode light source.

2. Description of Related Art

The light emitting diode (LED) is a mercury-free environmental friendly light source with advantages, such as low power consumption, high service life, fast response speed, no heat radiation and small volume. In 1996, the technology, which uses a blue LED with yttrium aluminum garnet (YAG) yellow phosphor together to generate a white light, was firstly issued by Nichia Corporation of Japan, and thereafter the white light emitting diode (WLED) has been formally commercialized. Due to the flourish development of the related technical industries in recent years, the luminous efficiency and the reliability of the WLED product have been increased continuously. Therefore, with the development trend of energy conservation and carbon reduction, the WLED, referred to as a green energy light source, is expected to gradually replace the conventional lighting apparatus such as an incandescent bulb, and will be used widely in industries, for example, general illumination apparatus, displayer, automobile, electronics and communications.

The white light emitted by the WLED is a two-wavelength light, three-wavelength light or four-wavelength light as a result of a mixture of multiple colors. At present, the manufacturing method of WLED includes: exciting a yellow phosphor with a blue LED; exciting a red phosphor and a green phosphor with a blue LED; exciting phosphors of multiple colors with a purple LED or a UV LED (e.g., the disclosure of Patent I340480 of Taiwan); using two to four kinds of LEDs to mix emitted light thereof to form a white light by adjusting individual brightness of the LEDs; and so on. The WLED which is manufactured by using the blue LED to excite the YAG phosphor to generate a yellow light and then mixing the yellow light and the blue light to generate a white light still has become a mainstream on the market due to its low cost and high efficiency. However, the color rendering of the WLED is incomparable with the conventional bulb and the power saving bulb. Therefore, a red phosphor should be added in order to realize a warm white light LED. When the blue LED is used together with the red phosphor and the green phosphor, both the color temperature and the color rendering are improved and the efficiency is also good.

The phosphor is a common luminescent material, wherein an inorganic phosphor generates a fluorescent light through electron transition. When the phosphor is excited by the light, the electrons in the phosphor are excited to the excited state of the high energy level and then the electrons return to the original low energy level state. At this time, the energy is radiated in the form of light. The inorganic phosphor is mainly constituted by a host lattice and an activator. Sometimes, if necessary, a co-activator or a sensitizer may be added to facilitate the luminous efficiency. The activator is used as a luminescence center while the host lattice delivers energy during the process of excitation. If a combination of the host lattice and the activator is changed, the wavelength of the light emitted by the phosphor can be changed so as to generate different luminescence colors. In addition, the chemical composition of the host lattice, the type and concentration of the activator and other factors all can affect the luminous efficiency of the phosphor. The development of the fluorescent material is from the early-stage unstable sulfide to the later silicon oxide (silicate) fluorescent material which has a good chemical stability. In recent years, the nitride/oxynitride fluorescent material is very popular.

At present, the typically phosphor includes an aluminum oxide phosphor, a silicon oxide phosphor and a nitride/oxynitride phosphor and so on. The Ce-doped YAG phosphor (mainly constituted by Y₃Al₅O₁₂:Ce) provided by Nichia Corporation of Japan in 1996, the TAG phosphor (mainly constituted by Tb₃Al₅O₁₂:Ce) provided by OSRAM GmbH of Germany in 1999 and the phosphor disclosed by Patent I353377 of Taiwan all are aluminum oxide phosphors using Ce as the activator. Moreover, Ba₂MgSi₂O₇:Eu phosphor provided by GE Company of U.S. in 1998 and the phosphor disclosed by Patent I306675 of Taiwan using Ce, Eu, Mn and so on as the activator and so on are silicon oxide phosphors. In addition, since the nitride and the oxynitride have excellent performances, such as good thermal stability, good chemical stability, nontoxicity and high strength, the phosphors which use the nitride and the oxynitride as the host lattices are also published gradually, such as the disclosures of U.S. Pat. No. 6,649,946, U.S. Pat. No. 6,632,379, U.S. Pat. No. 7,193,358, U.S. Pat. No. 7,525,127 and U.S. Pat. No. 7,569,987 and U.S. Patent Publications US 2009/0309485 and US 2006/0175716. However, in the general nitride/oxynitride phosphor, if Tb (Terbium) ion is used as the activator, its applicable value is always affected by the problems, such as the poor luminous efficiency and the absence of adjustability for the light color caused by a narrow emission band. Therefore, it is still needed to research and develop a phosphor which can overcome the disadvantages of the conventional technology and has a high applicable value.

### SUMMARY

In view of the disadvantages of the prior art, the present invention provides a phosphor suitable for a light emitting apparatus, and more particularly suitable for a LED light source, which meets the needs of the industrial application.

The present invention provides a phosphor which includes alkali earth ions, Si ion, N ion and Tb ion. Tb ion is used as a luminescence center. The phosphor is excited by an excitation light which can be absorbed by Tb ion and has an emission band with a full width at half maximum (FWHM) greater than 20 nanometers (nm). According to a specific embodiment of the present invention, the phosphor is excited by an excitation light which can be absorbed by Tb ion and has an emission band with a FWHM greater than 25 nm. According to a specific embodiment of the present invention, the alkali earth ions are Mg ion, Ca ion, Sr ion, Ba ion or a combination thereof. According to a specific embodiment of the present invention, the phosphor is excited by an excitation light having a wavelength of 250-600 nm and has an emission band with a FWHM greater than 20 nm. According to another specific embodiment of the present invention, the phosphor is excited by an excitation light having a wavelength of 350-600 nm and has an emission band with a FWHM greater than 20 nm.

According to a specific embodiment of the present invention, the phosphor is as shown in Formula (I):

TₓE_{y}Si_{z}NᵣTbₐL_{b}M_{c} (I),

wherein,

T is Mg, Ca, Sr or Ba;

E is Mg, Ca, Ba, Ti, Cu, Zn, B, Al, In, Sn, Sb, Bi, Ga, Y, La or Lu;

L is Li, Na or K;

M is Ce, Pr, Nd, Pm, Sm, Eu, Gd, Dy, Ho, Er, Tm, Yb or Mn: and

1.45≦x≦2.6, 0≦y≦0.5, 4.35≦z≦5.6, 7.4≦r≦9, 0.01≦a≦0.5, 0≦b≦0.5 and 0≦c≦0.5.

According to a specific embodiment of the present invention, the phosphor shown in Formula (I) is excited by an excitation light which can be absorbed by Tb ion and has an emission band with a FWHM greater than 20 nm. According to another specific embodiment of the present invention, the phosphor shown in Formula (I) is excited by an excitation light having a wavelength of 250-600 nm and has an emission band with a FWHM greater than 20 nm. According to a further specific embodiment of the present invention, the phosphor shown in Formula (I) is excited by an excitation light having a wavelength of 350-600 nm and has an emission band with a FWHM greater than 20 nm.

According to a specific embodiment of the present invention, the phosphor is excited by an excitation light which can be absorbed by Tb ion and has an excitation band with a FWHM greater than 50 nm. In a specific embodiment, an integral area of an excitation band strength in a wavelength of 350-600 nm of the phosphor of the present invention is 0.1 times greater than an integral area of an excitation band strength in a wavelength of 200-350 nm.

According to a specific embodiment of the present invention, the phosphor has an average particle size from 0.01 micrometers (μm) to 50 μm.

The phosphor of the present invention is suitable for a light emitting apparatus, and more particularly suitable for a LED. According to a specific embodiment of the present invention, the light emitting apparatus also includes a light source.

The phosphor of the present invention is excited by an excitation light and has a broad emission band. Therefore, it can overcome the disadvantages of the poor efficiency and the absence of adjustability for the light color in the conventional phosphors, and meets the industrial needs greatly.

### BRIEF DESCRIPTION OF THE DRAWINGS

FIG. 1 is a luminescent spectrum of Sr_{1.94}Si₅Tb_{0.03}Li_{0.03}N₈ phosphor according to a specific embodiment of the present invention;

FIG. 2 is an excitation spectrum of Sr_{1.94}Si₅Tb_{0.03}Li_{0.03}N₈ phosphor according to a specific embodiment of the present invention;

FIG. 3 is a luminescent spectrum of Sr_{1.4}Si_{5.6}Tb_{0.3}N_{8.7} phosphor according to a specific embodiment of the present invention; and

FIG. 4 is a luminescent spectrum of Sr₂Si₅Tb_{0.15}N_{8.15} phosphor according to a specific embodiment of the present invention.

### DETAILED DESCRIPTION

The implementation of the present invention is described by the particular specific embodiments as follows and those of skills in the art can know other advantages and functions of the present invention from the content disclosed by the specification. The present invention also can be implemented or applied by other different specific embodiments. Various modifications and changes can be made to details of the specification based on different views and applications, without departing from the spirit of the present invention.

Unless otherwise stated herein, the singular forms “a” and “the” used in to the specification and the accompanying claims include a plurality of individuals.

Unless otherwise stated herein, the term “or” used in the specification and the accompanying claims generally includes the meaning of “and/or”.

The present invention provides a phosphor which includes alkali earth ions, Si ion, N ion and Tb ion. Tb ion is used as a luminescence center. The phosphor is excited by an excitation light which can be absorbed by Tb ion and has an emission band with a full width at half maximum (FWHM) greater than 20 nm, preferably greater than 25 nm and more preferably greater than 50 nm.

The example of alkali earth ions includes, but not limited to, Mg ion, Ca ion, Sr ion, Ba and a combination thereof. Preferably, the alkali earth ions are Mg ion, Ca ion, Sr ion, Ba ion and a combination thereof.

According to a specific embodiment of the present invention, the phosphor is as shown in Formula (I):

TₓE_{y}Si_{z}NᵣTbₐL_{b}M_{c} (I),

wherein,

T is Mg, Ca, Sr or Ba;

E is Mg, Ca, Ba, Ti, Cu, Zn, B, Al, in, Sn, Sb, Bi, Ga, Y, La or Lu;

L is Li, Na or K;

M is Ce, Pr, Nd, Pm, Sm, Eu, Gd, Dy, Ho, Er, Tm, Yb or Mn; and

1.45≦x≦2.6, 0≦y≦0.5, 4.35≦z≦5.6, 7.4≦r≦9, 0.01≦a≦0.5, 0≦b≦0.5 and 0≦c≦0.5.

In the phosphor shown in Formula (I), Tb ion is used as a luminescence center. The phosphor is excited by an excitation light which can be absorbed by Tb ion and has an emission band with a FWHM greater than 20 nm, preferably greater than 25 nm and more preferably greater than 50 nm.

The phosphor of the present invention can be excited by an excitation light having a wavelength of 120-700 nm, preferably 200-700 nm, more preferably 250-650 nm and further more preferably 350-600 nm.

The phosphor of the present invention can be excited by an excitation light which can be absorbed by Tb ion and has an emission band with a FWHM greater than 20 nm, preferably greater than 25 nm and more preferably greater than 50 nm.

According to a specific embodiment of the present invention, the phosphor of the present invention is excited by an excitation light having a wavelength of 120-700 nm and has an emission band with a FWHM of 20-150 nm. According to another specific embodiment of the present invention, the phosphor of the present invention is excited by an excitation light having a wavelength of 120-700 nm and has an emission band with a FWHM greater than 20 nm, preferably greater than 25 nm and more preferably greater than 50 nm. In some aspects of these embodiments, the phosphor of the present invention is excited by an excitation light having a wavelength of 250-650 nm and has an emission band with a FWHM greater than 20 nm, preferably greater than 25 nm and more preferably greater than 50 nm. In some aspects of these embodiments, the phosphor of the present invention is excited by an excitation light having a wavelength of 350-600 nm and has an emission band with a FWHM greater than 20 nm, preferably greater than 25 nm and more preferably greater than 50 nm.

In a general phosphor, if Terbium (Tb) ion is used as the activator, its applicable value is always affected by the problems, such as the poor efficiency and the absence of adjustability for the light color caused by the narrow emission band.

The phosphor of the present invention is excited by an excitation light which can be absorbed by Tb ion and has a broad emission band in a luminescent spectrum. Therefore, the phosphor of the present invention can overcome the disadvantages of the poor efficiency and the absence of the adjustability for the light color in the conventional phosphors. According to a specific embodiment of the present invention, the phosphor of the present invention is excited by an excitation light which can be absorbed by Tb ion and it has an emission band with a FWHM greater than 20 nm in the luminescent spectrum, preferably greater than 25 nm and more preferably greater than 50 nm. According to a specific embodiment of the present invention, the phosphor of the present invention is excited by an excitation light which can be absorbed by Tb ion and it has an emission band with a FWHM greater than 20 nm in the luminescent spectrum from a yellow light area to a red light area, preferably greater than 25 nm and more preferably greater than 50 nm

The phosphor of the present invention is excited by an excitation light which can be absorbed by Tb ion and has a broad excitation band. According to a specific embodiment of the present invention, the phosphor is excited by an excitation light which can be absorbed by Tb ion and has an excitation band with a FWHM greater than 50 nm, preferably greater than 70 nm and more preferably greater than 90 nm. According to a specific embodiment of the present invention, the phosphor of the present invention is excited by an excitation light having a wavelength of 120-700 nm and has an excitation band with a FWHM greater than 50 nm, preferably greater than 70 nm and more preferably greater than 90 nm. According to a specific embodiment of the present invention, the phosphor has a broad excitation band in a wavelength range of 350-600 nm. The broad excitation band has a FWHM greater than 50 nm, preferably greater than 70 nm and more preferably greater than 90 nm.

According to a specific embodiment of the present invention, an integral area of an excitation band strength in a wavelength of 350-600 nm of the phosphor is greater than that of an excitation band strength in a wavelength of 200-350 nm. According to a specific embodiment of the present invention, an integral area of an excitation band strength having a wavelength of 350-600 nm of the phosphor is 0.1 times greater than an integral area of an excitation band strength having a wavelength of 200-350 nm. Preferably, an integral area of an excitation band strength having a wavelength of 350-600 nm of the phosphor is 0.2 times greater than, and preferably 0.3 times greater than an integral area of an excitation band strength having a wavelength of 200-350 nm.

An average particle size of the phosphor of the present invention is 0.01 μm to 50 μm, preferably 0.05 μm to 30 μm and more preferably 0.1 μm to 10 μm.

According to a specific embodiment of the present invention, the phosphor shown in Formula (I) is the phosphor shown in Formula (I-1) as follows:

TₓSi_{z}NᵣTb (I-1),

wherein, T, x, z, r and a are defined as above.

In the phosphor shown in Formula (I-1), T is preferably Ca, Sr or Ba. The phosphor shown in Formula (I-1) is preferably constituted by Sr, Si, N and Tb. The example of the phosphor shown in Formula (I-1) includes, but not limited to, Sr_{1.4}Si_{5.6}Tb_{0.3}N_{8.7}, Sr₂Si₅Tb_{0.15}N_{8.15}, Sr_{2.6}Si_{4.3}Tb_{0.01}N_{7.48} and Sr_{1.88}Si₅Tb_{0.08}N₈. According to a specific embodiment of the present invention, the phosphor shown in Formula (I-1) is excited by an excitation light which can be absorbed by Tb ion and has an emission band with a FWHM greater than 20 nm, preferably greater than 25 nm and more preferably greater than 50 nm. In some aspects of these embodiments, the phosphor shown in Formula (I-1) is excited by an excitation light having a wavelength of 250-600 nm and has an emission band with a FWHM greater than 20 nm, preferably greater than 25 nm and more preferably greater than 50 nm. In some aspects of these embodiments, the phosphor shown in Formula (I-1) is excited by an excitation light having a wavelength of 350-600 nm and has an emission band with a FWHM greater than 20 nm, preferably greater than 25 nm and more preferably greater than 50 nm. According to a specific embodiment of the present invention, the phosphor shown in Formula (I-1) is excited by an excitation light which can be absorbed by Tb ion and has an emission band from a yellow light area to a red light area in a luminescent spectrum. According to a specific embodiment of the present invention, the phosphor shown in Formula (I-1) is excited by an excitation light which can be absorbed by Tb ion and has an emission band with a FWHM greater than 20 nm in the luminescent spectrum from a yellow light area to a red light area, preferably greater than 25 nm and more preferably greater than 50 nm. According to a specific embodiment of the present invention, the phosphor shown in Formula (I-1) has a broad excitation band in a wavelength range of 350-600 nm. The broad excitation to band has a FWHM greater than 50 nm, preferably greater than 70 nm and more preferably greater than 90 nm.

According to a specific embodiment of the present invention, the phosphor shown in Formula (I) is the phosphor shown in Formula (I-2) as follows:

TₓSi_{z}NᵣTbₐL_{b} (I-2),

wherein, T, L, x, z, r, a and b are defined as above.

In the phosphor shown in Formula (I-2), T is preferably Ca, Sr or Ba. The phosphor shown in Formula (I-2) is preferably constituted by Ca, Sr or Ba, Si, N, Tb and Li, Na or K. The example of the phosphor shown in Formula (I-2) includes, but not limited to, Sr_{1.94}Si₅Tb_{0.03}Li_{0.03}N₈, Sr_{1.9}Si₅Tb_{0.03}Li_{0.03}N_{7.97}, Ca_{1.92}Si₅Tb_{0.04}Li_{0.04}N₈, Ba_{1.92}Si₅Tb_{0.04}Li_{0.04}N₈, Sr_{1.9}Si_{5.1}Tb_{0.1}K_{0.15}N_{8.22} and Sr₂Si_{5.2}Tb_{0.03}Na_{0.3}N_{8.4}. According to a specific embodiment of the present invention, the phosphor shown in Formula (I-2) is excited by an excitation light which can be absorbed by Tb ion and has an emission band with a FWHM greater than 20 nm, preferably greater than 25 nm and more preferably greater than 50 nm. In some aspects of these embodiments, the phosphor shown in Formula (I-2) is excited by an excitation light having a wavelength of 250-600 nm and has an emission band with a FWHM greater than 20 nm, preferably greater than 25 nm and more preferably greater than 50 nm. In some aspects of these embodiments, the phosphor shown in Formula (I-2) is excited by an excitation light having a wavelength of 350-600 nm and has an emission band with a FWHM greater than 20 nm, preferably greater than 25 nm and more preferably greater than 50 nm. According to a specific embodiment of the present invention, the phosphor shown in Formula (I-2) is excited by an excitation light which can be absorbed by Tb ion and has an emission band from a yellow light area to a red light area in a luminescent spectrum. According to a specific embodiment of the present invention, the phosphor shown in Formula (I-2) is excited by an excitation light which can be absorbed by Tb ion and has an emission band with a FWHM greater than 20 nm in the luminescent spectrum from a yellow light area to a red light area, preferably greater than 25 nm and more preferably greater than 50 nm. According to a specific embodiment of the present invention, the phosphor shown in Formula (I-2) has a broad excitation band in a wavelength range of 350-600 nm. The broad excitation band has a FWHM greater than 50 nm, preferably greater than 70 nm and more preferably greater than 90 nm.

According to a specific embodiment of the present invention, the phosphor shown in Formula (I) is the phosphor shown in Formula (I-3) as follows:

TₓSi_{z}NᵣTbₐM_{c} (I-3).

wherein, T, M, x, z, r, a and c are as defined as above.

In the phosphor shown in Formula (I-3), T is preferably Ca, Sr or Ba. In the phosphor shown in Formula (I-3), M is preferably Eu, Dy or Mn. The phosphor shown in Formula (I-3) is preferably constituted by Sr, Si, N, Tb and Eu, Dy or Mn. The example of the phosphor shown in Formula (I-3) includes, but not limited to, Sr_{2.5}Si_{4.8}Tb_{0.2}Mn_{0.2}N_{8.4}, Sr_{2.4}Si_{4.7}Tb_{0.3}Dy_{0.3}N_{8.47} and Sr₂Si₅Tb_{0.03}Eu_{0.03}N_{8.05}. According to a specific embodiment of the present invention, the phosphor shown in Formula (I-3) is excited by an excitation light which can be absorbed by Tb ion and has an emission band with a FWHM greater than 20 nm, preferably greater than 25 nm and more preferably greater than 50 nm. In some aspects of these embodiments, the phosphor shown in Formula (I-3) is excited by an excitation light having a wavelength of 250-600 nm and has an emission band with a FWHM greater than 20 nm, preferably greater than 25 nm and more preferably greater than 50 nm. In some aspects of these embodiments, the phosphor shown in Formula (I-3) is excited by an excitation light having a wavelength of 350-600 nm and has an emission band with a FWHM greater than 20 nm, preferably greater than 25 nm and more preferably greater than 50 nm. According to a specific embodiment of the present invention, the phosphor shown in Formula (I-3) is excited by an excitation light which can be absorbed by Tb ion and has an emission band from a yellow light area to a red light area in a luminescent spectrum. According to a specific embodiment of the present invention, the phosphor shown in Formula (I-3) is excited by an excitation light which can be absorbed by Tb ion and has an emission band with a FWHM greater than 20 nm in the luminescent spectrum from a yellow light area to a red light area, preferably greater than 25 nm and more preferably greater than 50 nm. According to a specific embodiment of the present invention, the phosphor shown in Formula (I-3) has a broad excitation band in a wavelength range of 350-600 nm. The broad excitation band has a FWHM greater than 50 nm, preferably greater than 70 nm and more preferably greater than 90 nm.

According to a specific embodiment of the present invention, the phosphor shown in Formula (I) is the phosphor shown in Formula (I-4) as follows:

TₓE_{y}Si_{z}NᵣTbₐ (I-4),

wherein, T, E, x, y, z, r and a are defined as above.

In the phosphor shown in Formula (I-4), T is preferably Ca, Sr or Ba. In the phosphor shown in Formula (I-4), E is preferably Ca, Ba or Bi, The phosphor shown in Formula (I-4) is preferably constituted by Sr, Si, N, Tb and Ca, Ba or Bi. The example of the phosphor shown in Formula (I-4) includes, but not limited to, Sr_{2.3}Si_{4.9}Tb_{0.08}Bi_{0.02}N_{8.17}, Sr_{2.2}Ca_{0.3}Si_{5.2}Tb_{0.1}N_{8.7}, Sr_{2.3}Ca_{0.05}Si_{4.8}Tb_{0.25}N_{8.22}, Sr_{1.7}Ba_{0.5}Si₅Tb_{0.15}N_{8.28}, Sr_{1.9}Ba_{0.1}Si_{5.1}Tb_{0.15}N_{8.28} and Sr_{1.5}Ba_{0.05}Si_{5.5}Tb_{0.3}N_{8.67}. According to a specific embodiment of the present invention, the phosphor shown in Formula (I-4) is excited by an excitation light which can be absorbed by Tb ion and has an emission band with a FWHM greater than 20 nm, preferably greater than 25 nm and more preferably greater than 50 nm. In some aspects of these embodiments, the phosphor shown in Formula (I-4) is excited by an excitation light having a wavelength of 250-600 nm and has an emission band with a FWHM greater than 20 nm, preferably greater than 25 nm and more preferably greater than 50 nm. In some aspects of these embodiments, the phosphor shown in Formula (I-4) is excited by an excitation light having a wavelength of 350-600 nm and has an emission band with a FWHM greater than 20 nm, preferably greater than 25 nm and more preferably greater than 50 nm. According to a specific embodiment of the present invention, the phosphor shown in Formula (I-4) is excited by an excitation light which can be absorbed by Tb ion and has an emission band from a yellow light area to a red light area in a luminescent spectrum. According to a specific embodiment of the present invention, the phosphor shown in Formula (I-4) is excited by an excitation light which can be absorbed by Tb ion and it has an emission band with a FWHM greater than 20 nm in the luminescent spectrum from a yellow light area to a red light area, preferably to greater than 25 nm and more preferably greater than 50 nm. According to a specific embodiment of the present invention, the phosphor shown in Formula (I-4) has a broad excitation band in a wavelength range of 350-600 nm. The broad excitation band has a FWHM greater than 50 nm, preferably greater than 70 nm and more preferably greater than 90 nm.

The phosphor of the present invention can be used as a red phosphor. The phosphor of the present invention is excited by an excitation light which can be absorbed by Tb ion and has an emission band from a yellow light area to a red light area in a luminescent spectrum. According to the present invention, the luminescent color of the phosphor is red. According to a specific embodiment of the present invention, the phosphor shown in Formula (I) is excited by an excitation light having a wavelength of 250-600 nm and has an emission band from a yellow light area to a red light area in a luminescent spectrum. According to a specific embodiment of the present invention, the phosphor shown in Formula (I) is excited by an excitation light having a wavelength of 350-600 nm and has an emission band from a yellow light area to a red light area in a luminescent spectrum.

At present, many red phosphors use Eu³⁺ as the activator, and its radioactive map is a sharp peak form. The luminous efficiency is difficult to increase and the light color lacks adjustability.

The phosphor of the present invention is excited by an excitation light which can be absorbed by Tb ion and has an emission band with a FWHM greater than 20 nm, preferably greater than 25 nm and more preferably greater than 50 nm in a luminescent spectrum. Therefore, the phosphor of the present invention can overcome the disadvantages of the poor efficiency and the absence of the adjustability for the light color in the conventional phosphors. According to the present invention, the phosphor is excited by an excitation light having a wavelength of 250-600 nm and it has an emission band with a FWHM greater than 20 nm in the luminescent spectrum, preferably greater than 25 nm and more preferably greater than 50 nm. According to the present invention, the phosphor is excited by an excitation light having a wavelength of 350-600 nm and it has an emission band with a FWHM greater than 20 nm in the luminescent spectrum, preferably greater than 25 nm and more preferably greater than 50 nm.)

According to a specific embodiment of the present invention, the phosphors shown in Formula (I-1) to Formula (I-4) are excited by an excitation light having a wavelength of 250-600 nm and they have an emission band with a FWHM greater than 20 nm in the luminescent spectrum, preferably greater than 25 nm and more preferably greater than 50 nm. According to a specific embodiment of the present invention, the phosphors shown in Formula (I-1) to Formula (I-4) are excited by an excitation light having a wavelength of 350-600 nm and they have an emission band with a FWHM greater than 20 nm in the luminescent spectrum, preferably greater than 25 nm and more preferably greater than 50 nm.

According to a specific embodiment of the present invention, the phosphors shown as Formulas Sr_{1.4}Si_{5.6}Tb_{0.3}N_{8.7}, Sr₂Si₅Tb_{0.15}N_{8.15}, Sr_{2.6}Si_{4.3}Tb_{0.01}N_{7.48}, Sr_{1.88}Si₅Tb_{0.08}N₈, Sr_{1.94}Si₅Tb_{0.03}Li_{0.03}N₈, Sr_{1.9}Si₅Tb_{0.03}Li_{0.03}N_{7.97}, Ca_{1.92}Si₅Tb_{0.04}Li_{0.04}N₈, Ba_{1.92}Si₅Tb_{0.04}Li_{0.04}N₈, Sr_{1.9}Si_{5.1}Tb_{0.1}K_{0.15}N_{8.22}, Sr₂Si_{5.2}Tb_{0.33}Na_{0.3}N_{8.4}, Sr_{2.5}Si_{4.8}Tb_{0.2}Mn_{0.2}N_{8.4}, Sr_{2.4}Si_{4.7}Tb_{0.3}Dy_{0.3}N_{8.47}, Sr₂Si₅Tb_{0.03}Eu_{0.03}N_{8.05}, Sr_{2.3}Si_{4.9}Tb_{0.08}Bi_{0.02}N_{8.17}, Sr_{2.2}Ca_{0.3}Si_{5.2}Tb_{0.1}N_{8.7}, Sr_{2.3}Ca_{0.05}Si_{4.8}Tb_{0.25}N_{8.22}, Sr_{1.7}Ba_{0.5}Si₅Tb_{0.15}N_{8.28}, Sr_{1.9}Ba_{0.1}Si_{5.1}Tb_{0.15}N_{8.28} and Sr_{1.5}Ba_{0.05}Si_{5.5}Tb_{0.3}N_{8.67} are excited by an excitation light having a wavelength of 250-600 nm, preferably having a wavelength of 350-600 nm and they have an emission band with a FWHM greater than 20 nm in the luminescent spectrum, preferably greater than 25 nm and more preferably greater than 50 nm.

The phosphor of the present invention may optionally include an additional co-activator and/or a sensitizer. The conventional co-activator and sensitizer in the art can be used, which will not be described anymore herein.

The phosphor of the present invention can be manufactured by any conventional phosphor manufacturing technology, for example, but not limited to, a solid state method, a sol-gel method, a co-precipitation method, a combustion synthesis method, a hydrothermal method, a chemical vapor phase method, a physical evaporation method and so on. The solid state method uses a dry mixing or a wet mixing manner to mix the raw materials and then calcinates/sinters the raw materials at a high temperature to obtain the phosphor. When the phosphor is manufactured by the solid state method, if necessary, a flux agent may be added.

The element raw material used to manufacture the phosphor of the present invention includes a metal or a compound containing the element. The example of the compound includes, but not limited to: oxide, nitride, sulfide, carbide, halogen compound, carbonate, nitrate, oxalate, sulfate, organic salt and so on. The element raw material used can serve as an activator, a sensitizer and/or a charge compensator for the phosphor. According to a specific embodiment of the present invention, when Sr ion and Tb ion are used to synthesize the phosphor, since the valence number of Sr ion is 2 and the valence number of Tb ion is 3 or 4, the charge compensation can be performed by adding non-divalent ions, such as alkali metal ions (Li, Na, K, Rb and Cs) to increase the luminous efficiency of the phosphor.

According to a specific embodiment of the present invention, the solid state method can be used to manufacture the phosphor of the present invention. In some aspects, the raw material needed to manufacture the phosphor of the present invention is mixed uniformly and then a heating reaction is performed. The heating temperature is 1,000° C. to 1,800° C., preferably 1100° C. to 1,700° C. and more preferably 1,200° C. to 1,600° C. The heating time is 0.5 hours to 72 hours, preferably 1 hour to 60 hours and more preferably 1.5 hours to 48 hours. The heating pressure is 0.3 atmosphere (atm) to 15 atm, preferable 0.5 atm to 10 atm and more preferably 0.7 atm to 5 atm. The heating reaction is performed in an atmosphere which may have a reducing capacity so as to change a bonding environment around the Tb ion, thereby changing a light emitting property of the Tb ion. The atmosphere includes hydrogen, ammonia, methane, carbon monoxide and/or other carbon-containing elements and the atmosphere may also include other gases, such as nitrogen and argon.

When the phosphor is manufactured, if necessary, the flux agent may be used. By adding the flux agent, the sintering reaction of the phosphor can be facilitated and the reaction temperature needed can be reduced. The example of the flux agent includes, but not limited to AlF₃, B₂O₃, H₃BO₃, BaO, BaCl₂, BaF₂, Bi₂O₃, CaHPO₄, CaF₂, CaSO₄, LiF, Li₂O, Li₂CO₃, LiNO₃, K₂O, KF, KCl, MgF₂, MoO₃, NaCl, Na₂O, NaF, Na₃AlF₆, NH₄F, NH₄Cl, (NH₄)₂HPO₄, SrF₂, SrS, CaS, SrSO₄, SrHPO₄, PbO, PbF₂, WO₃, carbamide, glucose, other low melting-point substances and a combination thereof.

If necessary, the phosphor manufactured by the solid state method can be further grinded. The example of manufacturing the phosphor of the present invention by the solid state method is as described in the following embodiments, but not limited to these.

The phosphor of the present invention can be used for a light emitting apparatus, for example, but not limited to, a photoluminescence apparatus, an electroluminescence apparatus, a cathode ray luminescence apparatus, and so on. The phosphor of the present invention is excited by an excitation light and has a broad emission band. Therefore, it can overcome the disadvantages of the poor efficiency and the absence of adjustability for the light color in the conventional phosphors, and meets the industrial needs greatly. According to a specific embodiment of the present invention, the phosphor of the present invention can be used for a photoluminescence apparatus. According to another specific embodiment of the present invention, the phosphor of the present invention can be used for a LED, for example, but not limited to, a LED which is excited by a blue light or a UV light. According to a specific embodiment of the present invention, the phosphor of the present invention can be used for a WLED. In addition, the phosphor of the present invention may be used independently or used together with other phosphors, for example, but not limited to, a yellow phosphor, a blue phosphor, a green phosphor and/or other red phosphors and so on.

The present invention also provides a light emitting apparatus which has the phosphor as shown in the above-mentioned Formula (I). The light emitting apparatus may be, for example, but not limited to, a photoluminescence apparatus, an electroluminescence apparatus, a cathode ray luminescence apparatus, and so on. According to a specific embodiment of the present invention, the light emitting apparatus is a photoluminescence apparatus. According to the present invention, the phosphor in the light emitting apparatus is excited by an excitation light and has a broad emission band. Therefore, it can overcome the disadvantages of the poor efficiency and the absence of adjustability for the light color in the conventional phosphors, and meets the industrial needs greatly. Generally, the light emitting apparatus may include, for example, a light source (e.g., a LED chip (such as a blue LED chip)) and a phosphor, wherein the phosphor is excited by an excitation light from the light source. According to a specific embodiment of the present invention, the light emitting apparatus of the present invention is a LED, for example, but not limited to, a LED which is excited by a blue light or a UV light. In some aspects of these embodiments, the light emitting apparatus includes a blue light source and a phosphor. According to a specific embodiment of the present invention, the light emitting apparatus of the present invention is a WLED. In addition, in the light emitting apparatus, the phosphor of the present invention may be used independently or used together with other phosphors, for example, but not limited to, a yellow phosphor, a blue phosphor, a green phosphor and/or other red phosphors and so on.

The light emitting apparatus of the present invention can be used for a general illumination, an illumination for display (such as a traffic sign), a medical apparatus illumination, an automobile electronic apparatus and so on. The light emitting apparatus of the present invention is also suitable for a backlight source of a liquid crystal display (LCD) and thus can be used for a displayer (such as a mobile phone, a digital camera, a television and a computer screen),

The present invention will be described more specifically through the embodiments. However, these embodiments are not used to limit the scope of the present invention. Unless otherwise specified, in the following embodiments and the comparative embodiments, “%” and “part by weight” used to represent the content of any component and the quantity of any substance are based on weight.

### EMBODIMENTS

### Embodiment 1

### Manufacturing and Analyzing Sr_{1.94}Si₅Tb_{0.03}Li_{0.03}N₈ Phosphor

The solid state method was used to manufacture Sr_{1.94}Si₅Tb_{0.03}Li_{0.03}N₈ phosphor. According to the cationic proportion of the chemical formula, Sr₃N₂, Si₃N₄, Tb₄O₇ and Li₃N powders were weighed and then mixed uniformly in a glove box. Next, the mixed powders were calcined in a reducing atmosphere containing mixed nitrogen and hydrogen gas at a calcination temperature of 1,400° C. for six hours to obtain Sr_{1.94}Si₅Tb_{0.03}Li_{0.03}N₈ phosphor. The crystal structure of the phosphor was confirmed as Sr₂Si₅N₈ structure through the X-ray diffraction (XRD) analysis. Through the analysis via a fluorescence spectrophotometer, under a wavelength of 270 nm which can be absorbed by Tb ion, the phosphor was excited to generate a broad emission band with a peak value at 620 nm having a FWHM of 96 nm, and the luminescent spectrum thereof is as shown in FIG. 1. An integral area of the excitation spectrum in the range of 350-600 nm was 1.06 times of an integral area in the range of 200-350 nm. Its excitation spectrum is as shown in FIG. 2, in which the spectrum has a to broad excitation band with a FWHM greater than 120 nm in the wavelength range of 350-600 nm.

### Embodiment 2

### Manufacturing and Analyzing Sr_{1.4}Si_{5.6}Tb_{0.3}N_{8.7} Phosphor

The solid state method was used to manufacture Sr_{1.4}Si_{5.6}Tb_{0.3}N_{8.7} phosphor. According to the cationic proportion of the chemical formula, Sr₃N₂, Si₃N₄ and Tb₄O₇ powders were weighed and then mixed uniformly in a glove box. Next, the mixed powders were calcined in a reducing atmosphere containing mixed nitrogen and hydrogen gas at a calcination temperature of 1,500° C. for six hours to obtain Sr_{1.4}Si_{5.6}Tb_{0.3}N_{8.7} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 607 nm having a FWHM of 86 nm. Its luminescent spectrum is as shown in FIG. 3.

### Embodiment 3

### Manufacturing and Analyzing Sr₂Si₅Tb_{0.15}N_{8.15} Phosphor

The solid state method was used to manufacture Sr₂Si₅Tb_{0.15}N_{8.15} phosphor. According to the cationic proportion of the chemical formula, Sr₃N₂, Si₃N₄ and Tb₄O₇ powders were weighed and then mixed uniformly in a glove box. Next, the mixed powders were calcined in a reducing atmosphere containing mixed nitrogen and hydrogen gas at a calcination temperature of 1,500° C. for six hours to obtain Sr₂Si₅Tb_{0.15}N_{8.15} is phosphor. The crystal structure of the phosphor was confirmed as Sr₂Si₅N₈ through the XRD analysis. Through the analysis via the fluorescence spectrophotometer, under a wavelength of 420 nm which can be absorbed by Tb ion, the phosphor was excited to generate a broad emission band with a peak value at 608 nm having a FWHM of 86 nm. Its luminescent spectrum is as shown in FIG. 4.

### Embodiment 4

### Manufacturing and Analyzing Sr_{2.6}Si_{4.3}Tb_{0.01}N_{7.48} Phosphor

The solid state method was used to manufacture Sr_{2.6}Si_{4.3}Tb_{0.01}N_{7.48} phosphor. According to the cationic proportion of the chemical formula, Sr₃N₂, Si₃N₄ and Tb₄O₇ powders were weighed and then mixed uniformly in a glove box. Next, the mixed powders were calcined in a reducing atmosphere containing mixed nitrogen and hydrogen gas at a calcination temperature of 1,500° C. for six hours to obtain Sr_{2.6}Si_{4.3}Tb_{0.01}N_{7.48} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 609 nm having a FWHM of 87 nm.

### Embodiment 5

### Manufacturing and Analyzing Sr_{1.9}Si₅Tb_{0.03}Li_{0.03}N_{7.97} Phosphor

The solid state method was used to manufacture Sr_{1.9}Si₅Tb_{0.03}Li_{0.03}N_{7.97} phosphor. According to the cationic proportion of the chemical formula, Sr₃N₂, Si₃N₄, Tb₄O₇ and LiF powders were weighed and then mixed uniformly in a glove box. Next, the mixed powders were calcined in the reducing atmosphere containing mixed nitrogen and hydrogen gas at a calcination temperature of 1,450° C. for six hours to obtain Sr_{1.9}Si₅Tb_{0.03}Li_{0.03}N_{7.97} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 613 nm having a FWHM of 88 nm.

### Embodiment 6

### Manufacturing and Analyzing Sr_{1.9}Si_{5.1}Tb_{0.1}K_{0.15}N_{8.22} Phosphor

The solid state method was used to manufacture Sr_{1.9}Si_{5.1}Tb_{0.1}K_{0.15}N_{8.22} phosphor. According to the cationic proportion of the chemical formula, Sr₃N₂, Si₃N₄, Tb₄O₇ and KCl powders were weighed and then mixed uniformly in a glove box. Next, the mixed powders were calcined in a reducing atmosphere containing mixed nitrogen and hydrogen gas under a calcination temperature of 1,600° C. for four hours to obtain Sr_{1.9}Si_{5.1}Tb_{0.1}K_{0.15}N_{8.22} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 610 nm having a FWHM of 86 nm.

### Embodiment 7

### Manufacturing and Analyzing Sr₂Si_{5.2}Tb_{0.03}Na_{0.3}N_{8.4} Phosphor

The solid state method was used to manufacture Sr₂Si_{5.2}Tb_{0.03}Na_{0.3}N_{8.4} phosphor. According to the cationic proportion of the chemical formula, Sr₃N₂, Si₃N₄, Tb₄O₇ and NaCl powders were weighed and then mixed uniformly in a glove box. Next, the mixed powders were calcined in a reducing atmosphere containing mixed nitrogen and hydrogen gas at a calcination temperature of to 1,600° C. for four hours to obtain Sr₂Si_{5.2}Tb_{0.03}Na_{0.3}N_{8.4} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 610 nm having a FWHM of 87 nm.

### Embodiment 8

### Manufacturing and Analyzing Sr_{2.3}Si_{4.9}Tb_{0.08}Bi_{0.02}N_{8.17} Phosphor

The solid state method was used to manufacture Sr_{2.3}Si_{4.9}Tb_{0.08}Bi_{0.02}N_{8.17} phosphor. According to the cationic proportion of the chemical formula, Sr₃N₂ Si₃N₄, Tb₄O₇ and Bi₂O₃ powders were weighed and then mixed uniformly in a glove box. Next, the mixed powders were calcined in a reducing atmosphere containing mixed nitrogen and hydrogen gas at a calcination temperature of 1,600° C. for four hours to obtain Sr_{2.3}Si_{4.9}Tb_{0.08}Bi_{0.02}N_{8.17} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 607 nm having a FWHM of 84 nm,

### Embodiment 9

### Manufacturing and Analyzing Sr_{2.5}Si_{4.8}Tb_{0.2}Mn_{0.2}N_{8.4} Phosphor

The solid state method was used to manufacture Sr_{2.5}Si_{4.8}Tb_{0.2}Mn_{0.2}N_{8.4} phosphor. According to the cationic proportion of the chemical formula, Sr₃N₂, Si₃N₄, Tb₄O₇ and Mn₂O₃ powders were weighed and then mixed uniformly in a glove box. Next, the mixed powders were calcined in a reducing atmosphere containing 95% nitrogen and 5% hydrogen gas at a calcination temperature of 1,600° C. for four hours to obtain Sr_{2.5}Si_{4.8}Tb_{0.2}Mn_{0.2}N_{8.4} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 612 nm having a FWHM of 85 nm.

### Embodiment 10

### Manufacturing and Analyzing Sr_{2.4}Si_{4.7}Tb_{0.3}Dy_{0.3}N_{8.47} Phosphor

The solid state method was used to manufacture Sr_{2.4}Si_{4.7}Tb_{0.3}Dy_{0.3}N_{8.47} phosphor. According to the cationic proportion of the chemical formula, Sr₃N₂, Si₃N₄, Tb₄O₇ and Dy₂O₃ powders were weighed and then mixed uniformly in a glove box. Next, the mixed powders were calcined in a reducing atmosphere containing mixed nitrogen and hydrogen gas at a calcination temperature of 1,600° C. for four hours to obtain Sr_{2.4}Si_{4.7}Tb_{0.3}Dy_{0.3}N_{8.47} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 620 nm having a FWHM of 93 nm.

### Embodiment 11

### Manufacturing and Analyzing Sr₂Si₅Tb_{0.03}Eu_{0.03}N_{8.05} Phosphor

The solid state method was used to manufacture Sr₂Si₅Tb_{0.03}Eu_{0.03}N_{8.05} phosphor. According to the cationic proportion of the chemical formula, Sr₃N₂, Si₃N₄, Tb₄O₇ and Eu₂O₃ powders were weighed and then mixed uniformly in a to glove box. Next, the mixed powders were calcined in a reducing atmosphere containing mixed nitrogen and hydrogen gas at a calcination temperature of 1,450° C. for six hours to obtain Sr₂Si₅Tb_{0.03}Eu_{0.03}N_{8.05} phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 620 nm having a FWHM of 90 nm.

### Embodiment 12

### Manufacturing and Analyzing Sr_{2.2}Ca_{0.3}Si_{5.2}Tb_{0.1}N_{8.7} Phosphor

The solid state method was used to manufacture Sr_{2.2}Ca_{0.3}Si_{5.2}Tb_{0.1}N_{8.7} (6 wt % H₃BO₃) phosphor. According to the cationic proportion of the chemical formula, Sr₃N₂, CaO, Si₃N₄ and Tb₄O₇ powders were weighed and 6 wt % of the flux agent H₃BO₃ was added based on the total weight of the reactant. Then they were mixed uniformly in a glove box. Next, the mixed powders were calcined in a reducing atmosphere containing mixed nitrogen and hydrogen gas at a calcination temperature of 1,400° C. for eight hours to obtain Sr_{2.2}Ca_{0.3}Si_{5.2}Tb_{0.1}N_{8.7} (6 wt % H₃BO₃) phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 608 nm having a FWHM of 73 nm.

### Embodiment 13

### Manufacturing and Analyzing Sr_{1.7}Ba_{0.5}Si₅Tb_{0.15}N_{8.28} Phosphor

The solid state method was used to manufacture Sr_{1.7}Ba_{0.5}Si₅Tb_{0.15}N_{8.28} (10 wt % NH₄Cl) phosphor. According to the cationic proportion of the chemical formula, Sr₃N₂, Ba₃N₂, Si₃N₄ and Tb₄O₇ powders were weighed and 10 wt % of the flux agent NH₄Cl was added based on the total weight of the reactant. Then they were mixed uniformly in a glove box. Next, the mixed powders were calcined in a reducing atmosphere containing mixed nitrogen and hydrogen gas at a calcination temperature of 1,400° C. for eight hours to obtain Sr_{1.7}Ba_{0.5}Si₅Tb_{0.15}N_{8.28} (10 wt % NH₄Cl) phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 607 nm having a FWHM of 78 nm.

### Embodiment 14

### Manufacturing and Analyzing Sr_{2.3}Ca_{0.05}Si_{4.8}Tb_{0.25}N_{8.22} Phosphor

The solid state method was used to manufacture Sr_{2.3}Ca_{0.05}Si_{4.8}Tb_{0.25}N_{8.22} (2 wt % NH₄F) phosphor. According to the cationic proportion of the chemical formula, Sr₃N₂, CaO, Si₃N₄ and Tb₄O₇ powders were weighed and 2 wt % of the flux agent NH₄F was added based on the total weight of the reactant. Then they were mixed uniformly in a glove box. Next, the mixed powders were calcined in a reducing atmosphere containing mixed nitrogen and hydrogen gas at a calcination temperature of 1,400° C. for eight hours to obtain Sr_{2.3}Ca_{0.05}Si_{4.8}Tb_{0.25}N_{8.22} (2 wt % NH₄F) phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 608 nm having a FWHM of 84 nm.

### Embodiment 15

### Manufacturing and Analyzing Sr_{1.9}Ba_{0.1}Si_{5.1}Tb_{0.15}N_{8.28} Phosphor

The solid state method was used to manufacture Sr_{1.9}Ba_{0.1}Si_{5.1}Tb_{0.15}N_{8.28} (3 wt % H₃BO₃) phosphor. According to the cationic proportion of the chemical formula, Sr₃N₂, Ba₃N₂, Si₃N₄ and Tb₄O₇ powders were weighed and 3 wt % of the flux agent H₃BO₃ was added based on the total weight of the reactant. Then they were mixed uniformly in a glove box. Next, the mixed powders were calcined in a reducing atmosphere containing mixed nitrogen and hydrogen gas at a calcination temperature 1,400° C. for eight hours to obtain Sr_{1.9}Ba_{0.1}Si_{5.1}Tb_{0.15}N_{8.28} (3 wt % H₃BO₃) phosphor. The crystal structure of the phosphor was confirmed as Sr₂Si₅N₈ structure trough the XRD analysis. Through the analysis via the fluorescence spectrophotometer, under a wavelength of 420 nm which can be absorbed by Tb ion, the phosphor was excited to generate a broad emission band with a peak value at 611 nm having a FWHM of 87 nm,

### Embodiment 16

### Manufacturing and Analyzing Sr_{1.5}Ba_{0.05}Si_{5.5}Tb_{0.3}N_{8.67} Phosphor

The solid state method was used to manufacture Sr_{1.5}Ba_{0.05}Si_{5.5}Tb_{0.3}N_{8.67} (4 wt % NH₄Cl) phosphor. According to the cationic proportion of the chemical formula, Sr₃N₂, Ba₃N₂, Si₃N₄ and Tb₄O₇ powders were weighed and 4 wt % of the flux agent NH₄Cl was added based on the total weight of the reactant. Then they were mixed uniformly in a glove box. Next, the mixed powders were calcined in a reducing atmosphere containing mixed nitrogen and hydrogen gas at a calcination temperature of 1,400° C. for eight hours to obtain Sr_{1.5}Ba_{0.05}Si_{5.5}Tb_{0.3}N_{8.67} (4 wt % NH₄Cl) phosphor. The crystal structure of the phosphor was confirmed as Sr₂Si₈N₈ structure through the XRD analysis. Through the analysis via the fluorescence spectrophotometer, under a wavelength of 420 nm which can be absorbed by Tb ion, the phosphor was excited to generate a broad emission band with a peak value at 608 nm having a FWHM of 85 nm.

### Embodiment 17

### Manufacturing and Analyzing Sr_{1.88}Si₅Tb_{0.08}N₈ Phosphor

The solid state method was used to manufacture Sr_{1.88}Si₅Tb_{0.08}N₈ phosphor. According to the cationic proportion of the chemical formula, Sr₃N₂, Si₃N₄ and TbCl₃ powders were weighed and then mixed uniformly in a glove box. Next, the mixed powders were calcined in a reducing atmosphere containing mixed nitrogen and hydrogen gas at a calcination temperature of 1,200° C. for two hours to obtain Sr_{1.88}Si₅Tb_{0.08}N₈ phosphor. The crystal structure of the phosphor was confirmed as Sr₂Si₅N₈ structure trough the XRD analysis. Through the analysis via the fluorescence spectrophotometer, under a wavelength of 420 nm which can be absorbed by Tb ion, the phosphor was excited to generate a broad emission band with a peak value at 606 nm having a FWHM of 84 nm.

### Embodiment 18

### Manufacturing and Analyzing Ca_{1.92}Si₅Tb_{0.04}Li_{0.04}N₈ Phosphor

The solid state method was used to manufacture Ca_{1.92}Si₅Tb_{0.04}Li_{0.04}N₈ to phosphor. According to the cationic proportion of the chemical formula, CaH₂, Si₃N₄, Tb₂O₃, Li₃N powders were weighed and then mixed uniformly in a glove box. Next, the mixed powders were calcined in a reducing atmosphere containing mixed nitrogen and hydrogen gas at a calcination temperature of 1,500° C. for four hours to obtain Ca_{1.92}Si₅Tb_{0.04}Li_{0.04}N₈ phosphor. The crystal structure of the phosphor was confirmed as Ca₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 603 nm having a FWHM of 99 nm.

### Embodiment 19

### Manufacturing and Analyzing Ba_{1.92}Si₅Tb_{0.04}Li_{0.04}N₈ Phosphor

The solid state method was used to manufacture Ba_{1.92}Si₅Tb_{0.04}Li_{0.04}N₈ phosphor. According to the cationic proportion of the chemical formula, Ba₃N₂, Si₃N₄, TbCl₃, Li₃N powders were weighed and then mixed uniformly in a glove box. Next, the mixed powders were calcined in a reducing atmosphere containing mixed nitrogen and hydrogen gas at a calcination temperature of 1,250° C. for four hours to obtain Ba_{1.92}Si₅Tb_{0.04}Li_{0.04}N₈ phosphor. The crystal structure of the phosphor was confirmed as Sr₂Si₅N₈ structure through the XRD analysis. Through the analysis via the fluorescence spectrophotometer, under a wavelength of 420 nm which can be absorbed by Tb ion, the phosphor was excited to generate a broad emission band with a peak value at 580 nm having a FWHM of 85 nm.

### Embodiment 20

The phosphors Sr_{1.94}Si₅Tb_{0.03}Li_{0.03}N₈, Sr₂Si₅Tb_{0.03}Eu_{0.03}N_{8.05}, Sr_{1.7}Ba_{0.5}Si₅Tb_{0.15}N_{8.28} and Ca_{1.92}Si₅Tb_{0.04}Li_{0.04}N₈ synthesized by Embodiments 1, 11, 13 and 18 were mixed with the epoxy resign and then were encapsulated on the blue LED. The blue light wavelength of the chip was 460 nm. After the LED encapsulation test, the blue light chip can excite the encapsulated phosphor to generate a red light. After the blue light of the chip was mixed with the red light of the fluorescent material, a purplish red light appears, which proves the congruence between the fluorescent material of the present invention and the blue LED.

The phosphor of the present invention is excited by an excitation light and has a broad emission band. As such, the drawbacks in the conventional phosphors like the poor luminous efficiency and lacking of adjustability for the light color have been overcome. On the other hand, the phosphor according to the present invention exhibits excellent performance, such as good heat stability, good chemical stability, nontoxicity and high strength, urgently required in the industry. The above-mentioned embodiments are only used to describe the composition and the manufacturing method of the present invention exemplarily rather than limiting the present invention. Those of skills in the art can modify and change the above-mentioned embodiments, without departing from the spirit and scope of the present invention. Therefore, the right protection scope of the present invention shall be defined by the following claims.

What is claimed is:

1. A phosphor comprising alkali earth ions, Si ion, N ion and Tb ion, wherein Tb ion is used as a luminescence center and the phosphor is excited by an excitation light which can be absorbed by Tb ion and has an emission band with a full width at half maximum greater than 20 nm.

2. The phosphor of claim 1, wherein the alkali earth ions are Mg ion, Ca ion, Sr ion, Ba ion or a combination thereof.

3. The phosphor of claim 1, also comprising Mg ion, Ca ion, Sr ion, Ba ion, Ti ion, Cu ion, Zn ion, B ion, Al ion, In ion, Sn ion, Sb ion, Bi ion, Ga ion, Y ion, La ion, Lu ion, Li ion, Na ion, K ion, Ce ion, Pr ion, Nd ion, Pm ion, Sm ion, Eu ion, Gd ion, Dy ion, Ho ion, Er ion, Tm ion, Yb ion, Mn ion or a combination thereof.

4. The phosphor of claim 1, which is as shown in Formula (I):
TₓE_{y}Si_{z}NᵣTbₐL_{b}M_{c} (I)
wherein,
T is Mg, Ca, Sr or Ba;
E is Mg, Ca, Ba, Ti, Cu, Zn, B, Al, In, Sn, Sb, Bi, Ga, Y, La or Lu;
L is Li, Na or K;
M is Ce, Pr, Nd, Pm, Sm, Eu, Gd, Dy, Ho, Er, Tm, Yb or Mn;
1.45≦x≦2.6, 0≦y≦0.5, 4.35≦z≦5.6, 7.4≦r≦9, 0.01≦a≦0.5, 0≦b≦0.5; and
wherein, Tb ion is used as the luminescence center and the phosphor is excited by an excitation light which can be absorbed by Tb ion and has an emission band with a full width at half maximum greater than 20 nm.

5. The phosphor of claim 4, wherein the phosphor is excited by an excitation light which can be absorbed by Tb ion and has an emission band with a full width at half maximum greater than 25 nm.

6. The phosphor of claim 4, wherein the phosphor is excited by an excitation light having a wavelength of 350-600 nm and has an emission band with a full width at half maximum greater than 20 nm.

7. The phosphor of claim 4, wherein the phosphor has an excitation band with a full width at half maximum greater than 50 nm in a wavelength range of 350-600 nm.

8. The phosphor of claim 4, wherein an integral area of an excitation band strength in a wavelength of 350-600 nm of the phosphor is 0.1 times greater than an integral area of an excitation band strength in a wavelength of 200-350 nm.

9. The phosphor of claim 4, wherein the manufacturing of the phosphor comprises a synthetic reaction which is implemented in a reducing atmosphere under a temperature greater than 1,100° C.

10. The phosphor of claim 4, wherein an average particle size of the phosphor is 0.01 μm to 50 μm.

11. The phosphor of claim 4, having Formula TₓSi_{z}NᵣTbₐ.

12. The phosphor of claim 4, having Formula TₓSi_{z}NᵣTbₐL_{b}.

13. The phosphor of claim 4, having Formula TₓSi_{z}NᵣTbₐM_{c}.

14. The phosphor of claim 4, having Formula TₓE_{y}Si_{z}NᵣTbₐ.

15. A light emitting apparatus, having the phosphor of claim 1.

16. The light emitting apparatus of claim 15, which is a LED.
